(19) United States
(12) Patent Application Publication
(10) Pub. No.: US 2016/0055001 A1
(43) Pub. Date: Feb. 25, 2016

(54) LOW POWER INSTRUCTION BUFFER FOR HIGH PERFORMANCE PROCESSORS

(71) Applicant: Oracle International Corporation, Redwood City, CA (US)

(72) Inventors: Gideon Levinsky, Cedar Park, TX (US); Jama Barreh, Austin, TX (US); Jia Feng, San Jose, CA (US)

(21) Appl. No.: 14/463,270

(22) Filed: Aug. 19, 2014

(51) Int. Cl. G06F 9/38

(52) U.S. Cl. CPC G06F 9/3836

(57) ABSTRACT

A method for operating an instruction buffer is disclosed. A read pointer that includes a value indicative of a given bank of a plurality of banks is received. A subset of the of the plurality of banks may then be selected dependent upon the read pointer and one or more control bits associated with an instruction stored at a location specified by the read pointer. The subset of the plurality of banks may then be activated, and an instruction read from each activated bank to form a dispatch group.

### BACKGROUND

1. Technical Field

This invention relates to computing systems, and more particularly, to the transmission of transactions between functional blocks within computing systems.

2. Description of the Related Art

Computing systems may include multiple processors or nodes, each of which may include multiple processor cores. Such systems may also include various Input/Output (I/O) devices, to which each processor may send data, or from which each processor may receive data. For example, I/O devices may include ethernet network interface cars (NICs) that allow the processors to communicate with other computing systems and external peripherals, such as printers, for example. Various forms of storage devices, such as, e.g., mechanical or solid-state drives, may also be included within a computing system.

During operation, each processor core may retrieve program instructions from system memory. A processor core may then determine what operations to perform based on the retrieved program instructions, and then execute such operations. The process of retrieving and executing program instructions from memory is commonly referred to as an “instruction cycle.” The retrieval portion of an instruction cycle is typically referred to as a “fetch” or “instruction fetch.” Some processing cores may include a dedicated functional block, an Instruction Fetch Unit (IFU), which may include various counters and/or state machines used to determine an address in system memory for a next program instruction.

Some processor cores may support the execution of multiple sequences of program instructions (or “threads”). In such cases, as instructions from one thread are fetched from system memory, they may be temporarily stored in a buffer, or other suitable memory structure, until a processor core is ready to execute tasks associated with that particular thread. When the processor core is ready to execute the next set of program instructions, program instructions previously stored in the buffer may be retrieved (or “dispatched”) from the buffer and sent to other functional blocks within the processor core.

### SUMMARY OF THE EMBODIMENTS

Various embodiments for a circuit and method for operating an instruction buffer are disclosed. Broadly speaking, an apparatus and method are contemplated in which circuitry may be configured to receive a read pointer, where the read pointer includes a value indicative of a given bank of the plurality of banks. The circuitry may be further configured to select a subset of the plurality of banks dependent upon the read pointer and one or more control bits associated with an instruction stored at a location specified by the read pointer. The subset of the plurality banks may then be activated by the circuitry and an instruction read from each bank of the subset of the plurality of banks to generate a dispatch group.

In one embodiment, the circuitry may be further configured to read the one or more control bits from a memory.

In a particular embodiment, the circuitry may be further configured to increment the read pointer responsive to a determination that reading an instruction from each bank of the subset of the plurality of banks has completed.

### BRIEF DESCRIPTION OF THE DRAWINGS

The following detailed description makes reference to the accompanying drawings, which are now briefly described.

FIG. 1 illustrates an embodiment of a system on a chip.

FIG. 2 illustrates another embodiment of a system on a chip.

FIG. 3 illustrates a block diagram of an embodiment of a processor core.

FIG. 4 illustrates a block diagram of an embodiment of an instruction buffer.

FIG. 5 illustrates a block diagram of instructions stored in a multi-bank instruction buffer.

FIG. 6 illustrates a flow diagram depicting an embodiment of a method for fetching instructions in a computing system.

FIG. 7 illustrates a flow diagram depicting an embodiment of a method for dispatching instructions a computing system.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form illustrated, but on the contrary, the intention is to cover all modifications, equivalents and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph (f) interpretation for that unit/circuit/component. More generally, the recitation of any element is expressly intended not to invoke 35 U.S.C. §112, paragraph (f) interpretation for that element unless the language “means for” or “step for” is specifically recited.

### DETAILED DESCRIPTION OF EMBODIMENTS

Multiple processors, each including multiple processor cores, may be included in a computing system. As part of an instruction cycle, each processor core may fetch program instructions from system memory and store the fetched instructions in an instruction buffer. As a processor core completes execution of a program instruction, another program instruction is dispatched from the instruction buffer.

An instruction buffer may include multiple banks of dual-port (i.e., one read port and one write port) memory cells, and may be configured to operate in a First In First Out (FIFO) fashion. In some processor cores, an instruction buffer may allow for a sufficient number of entries to support multiple program instructions from multiple execution threads. Program instructions may be dispatched from an instruction buffer every processor core cycle, which may be accomplished by parallel reads from each bank of the instruction buffer. Such operation may increase power consumption, further contributing to overall power consumption of a computing system. High power consumption may reduce overall performance and increase cost of a computing system through the addition of cooling measures.

The embodiments illustrated in the drawings and described below may provide techniques for accessing an instruction buffer to dispatch fetched instructions while providing reduced power consumption by limiting a number of banks accessed during the dispatch of instructions dependent upon information regarding breaks within the instructions.

### System-on-a-Chip Overview

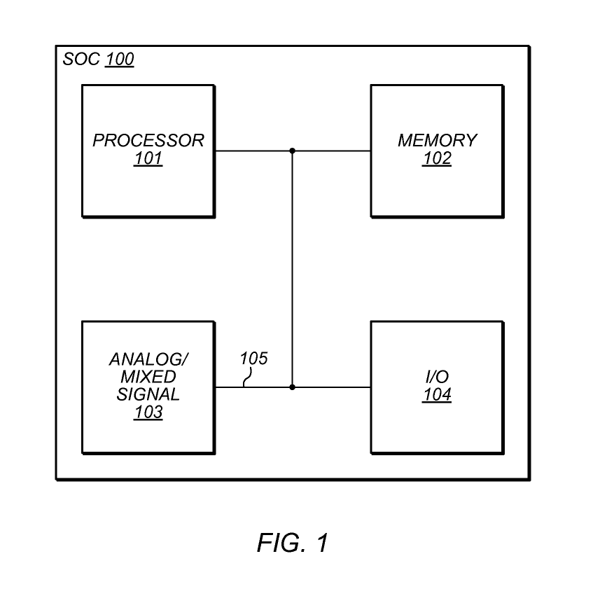

A block diagram of an SoC is illustrated in FIG. 1. In the illustrated embodiment, SoC 100 includes a processor 101 coupled to memory block 102, and analog/mixed-signal block 103, and I/O block 104 through internal bus 105. In various embodiments, SoC 100 may be configured for use in a mobile computing application such as, e.g., a tablet computer or cellular telephone, or a server-based computing application, or any other suitable computing application. Transactions on internal bus 105 may be encoded according to one of various communication protocols. For example, transactions may be encoded using Peripheral Component Interconnect Express (PCIe®), or any other suitable communication protocol.

Memory block 102 may include any suitable type of memory such as a Dynamic Random Access Memory (DRAM), a Static Random Access Memory (SRAM), a Read-only Memory (ROM), Electrically Erasable Programmable Read-only Memory (EEPROM), a FLASH memory, Phase Change Memory (PCM), or a Ferroelectric Random Access Memory (FeRAM), for example. It is noted that in the embodiment of an SoC illustrated in FIG. 1, a single memory block is depicted. In other embodiments, any suitable number of memory blocks may be employed.

As described in more detail below, processor 101 may, in various embodiments, be representative of a general-purpose processor that performs computational operations. For example, processor 101 may be a central processing unit (CPU) such as a microprocessor, a microcontroller, an application-specific integrated circuit (ASIC), or a field-programmable gate array (FPGA).

Analog/mixed-signal block 103 may include a variety of circuits including, for example, a crystal oscillator, a phase-locked loop (PLL), an analog-to-digital converter (ADC), and a digital-to-analog converter (DAC) (all not shown). In other embodiments, analog/mixed-signal block 103 may be configured to perform power management tasks with the inclusion of on-chip power supplies and voltage regulators.

I/O block 104 may be configured to coordinate data transfer between SoC 101 and one or more peripheral devices. Such peripheral devices may include, without limitation, storage devices (e.g., magnetic or optical media-based storage devices including hard drives, tape drives, CD drives, DVD drives, etc.), audio processing subsystems, or any other suitable type of peripheral devices. In some embodiments, I/O block 104 may be configured to implement a version of Universal Serial Bus (USB) protocol or IEEE 1394 (Firewire®) protocol.

I/O block 104 may also be configured to coordinate data transfer between SoC 101 and one or more devices (e.g., other computer systems or SoCs) coupled to SoC 101 via a network. In one embodiment, I/O block 104 may be configured to perform the data processing necessary to implement an Ethernet (IEEE 802.3) networking standard such as Gigabit Ethernet or 10-Gigabit Ethernet, for example, although it is contemplated that any suitable networking standard may be implemented. In some embodiments, I/O block 104 may be configured to implement multiple discrete network interface ports.

SoCs, such as SoC 100, may be manufactured in accordance with one of various semiconductor manufacturing processes. During manufacture, transistors may be fabricated in a silicon substrate using a series of masking, deposition, and implantation steps. Once the transistors have been fabricated, they may be wired together to form various circuits, such as, e.g., logic gates, amplifiers, and the like. In order to wire the transistors together, multiple metal layers are deposited onto the silicon substrate, each layer separated by an insulating layer, such as, silicon dioxide, for example. Connections may be made from one metal layer to another by etching holes in one of the insulating layers and filling the hole with metal, creating what is commonly referred to as “vias.”

Each metal layer may be fabricated using different materials, such as, e.g., aluminum, copper, and the like, and may accommodate numerous individual wires. Due to differences in lithography between the various metal layers, different metal layers may allow for different minimum wire widths and spaces. Moreover, the different materials used for the different metal layers may result in different thickness of wires on the various metal layers. The combination of different widths, spaces, and thickness of wires on the different metal layers may result in different physical characteristics, such as, e.g., resistance, capacitance, and inductance, between wires on different metal layers. The different physical characteristics of the various wires could result in different time constants (i.e., the product of the resistance of a wire and the capacitance of a wire). Wires with smaller time constants are able to handle higher frequency data transmission than wires with larger time constants. In some designs, wires fabricated on the top most levels of metals are thicker, wider, and have smaller time constants, making such wires attractive for high speed data transmission.

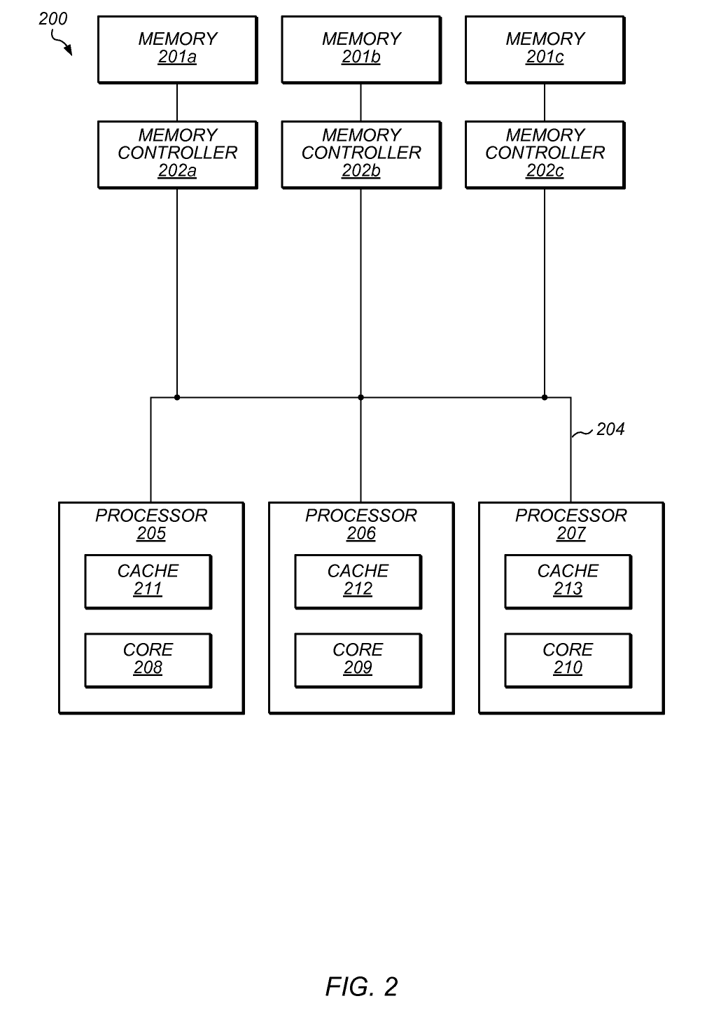

Turning to FIG. 2, another embodiment of an SoC is depicted. In the illustrated embodiment, SoC 200 includes a memories 201a-c, memory controllers 202a-c, and processors 205, 206, and 207. Processor 205 includes processor core 208 and cache memory 211. Similarly, processor 206 includes processor core 209 and cache memory 212, and processor 207 includes processor core 210 and cache memory 213.

Each of processors 205, 206, and 207 are coupled to memory controllers 202a-c through bus 204. It is noted that although only three processors, three memory controllers, and three memories are depicted, in other embodiments, different numbers of processors, memory controllers, and memories, as well as other functional blocks (also referred to herein as “agents”) may be coupled to bus 204. In some embodiments, bus 204 may correspond to bus 105 of SoC 100 as illustrated in FIG. 1. Bus 204 may be encoded in one of various communication protocols that may support the transmission of requests and responses between processors 205, 206 and 207, and memory controllers 202a-c. Bus 204 may, in various embodiments, include multiple networks. For example, bus 204 may include a ring network, a point-to-point network, and a mesh network. As described below in more detail, different types of communications, such as, e.g., requests, may be transmitted over different networks. It is noted that although bus 204 is depicted as coupling processors to memory controllers, in other embodiments, a similar type of bus may be employed to couple multiple processing cores to a hierarchy of cache memories, or other functional blocks, within a single processor.

Each of memories 201a-c may, in some embodiments, include one or more DRAMs, or other suitable memory device. Each of memories 201a-c is coupled to a respective one of memory controllers 202a-c, each of which may be configured to generate control signals necessary to perform read and write operations to the corresponding memory. In some embodiments, memory controllers 202a-c may implement one of various communication protocols, such as, e.g., a synchronous double data rate (DDR) interface.

Each of memory controllers 202a-c may be configured to receive requests and responses (collectively referred to as “transactions”) from processors 205, 206, and 207. Each received transaction may be evaluated in order to maintain coherency across cache memories 211, 212, and 213, and memories 201a-c. Coherency may be maintained using one of various coherency protocols such as, e.g., Modified Share Invalid (MSI) protocol, Modified Owned Exclusive Shared Invalid (MOESI) protocol, or any other suitable coherency protocol. In some embodiments, a specialized functional block may be configured to monitor transactions and enforce the chosen coherency protocol.

Cache memories 211, 212, and 213 may be designed in accordance with one of various design styles. For example, in some embodiments, cache memories 211, 212, and 213 may be fully associative, while in other embodiments, the memories may be direct-mapped. Each entry in the cache memories may include a “tag” (which may include a portion of the address of the actual data fetched from main memory).

It is noted that embodiment of an SoC illustrated in FIG. 2 is merely an example. In other embodiments, different numbers of processors and other functional blocks may be employed.

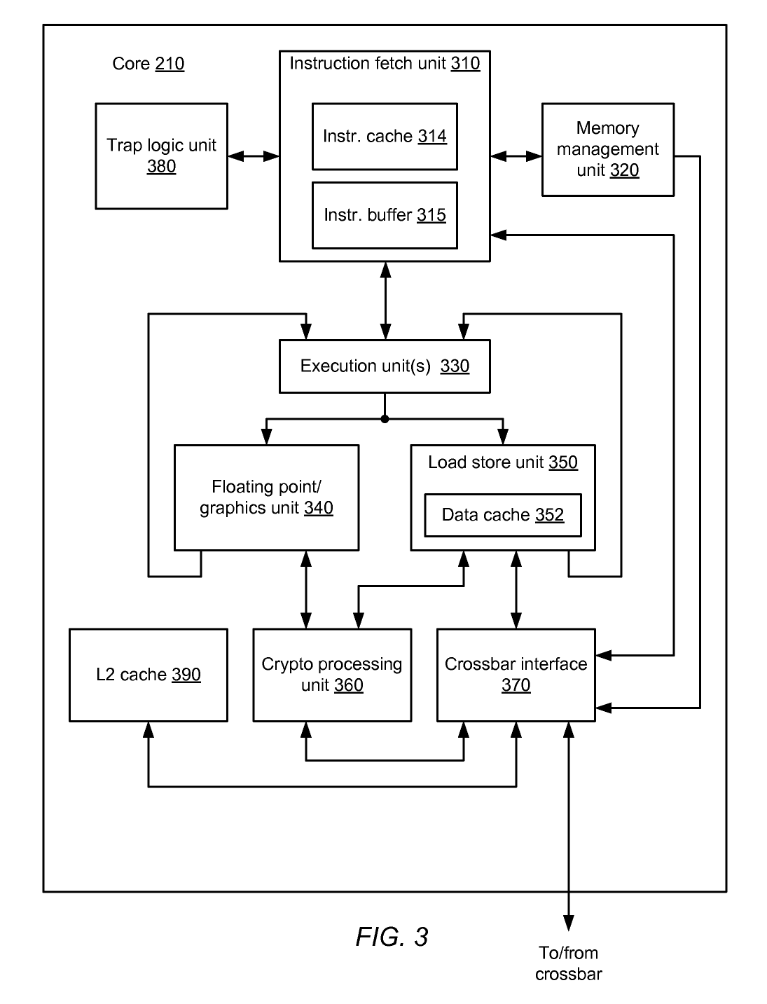

A possible embodiment of core 210 configured is illustrated in FIG. 3. In the illustrated embodiment, core 210 includes an instruction fetch unit (IFU) 310 coupled to a memory management unit (MMU) 320, a crossbar interface 370, a trap logic unit (TLU) 380, a L2 cache memory 390, and one or more of execution units 330. Execution unit 330 is coupled to both a floating point/graphics unit (FGU) 340 and a load store unit (LSU) 350. Each of the latter units is also coupled to send data back to each of execution units 330. Both FGU 340 and LSU 350 are coupled to a crypto processing unit 360. Additionally, LSU 350, crypto processing unit 360, L2 cache memory 390 and MMU 320 are coupled to crossbar interface 370, which may in turn be coupled to crossbar 220 shown in FIG. 2.

Instruction fetch unit 310 may be configured to provide instructions to the rest of core 210 for execution. In the illustrated embodiment, IFU 310 may be configured to perform various operations relating to the fetching of instructions from cache or memory, the selection of instructions from various threads for execution, and the decoding of such instructions prior to issuing the instructions to various functional units for execution. Instruction fetch unit 310 further includes an instruction cache 314. In one embodiment, IFU 310 may include logic to maintain fetch addresses (e.g., derived from program counters) corresponding to each thread being executed by core 210, and to coordinate the retrieval of instructions from instruction cache 314 according to those fetch addresses.

IFU 310 may also include one or more counters 315. Counters 315 may be configured to increment in response to various events, such as, e.g., a new instruction being fetched, the occurrence of a branch, and the like. Counters as described herein, may be a sequential logic circuit configured to cycle through a pre-determined set of logic states. A counter may include one or more state elements such as, e.g., flip-flop circuits, and may be designed according to one of various designs styles including asynchronous (ripple counters), synchronous counters, ring counters, and the like.

If core 210 is configured to execute only a single processing thread and branch prediction is disabled, fetches for the thread may be stalled when a branch is reached until the branch is resolved. Once the branch is evaluated, fetches may resume. In cases where core 210 is capable of executing more than one thread and branch prediction is disabled, a thread that encounters a branch may yield or reallocate its fetch slots to another execution thread until the branch is resolved. In such cases, an improvement in processing efficiency may be realized. In both single and multi-threaded modes of operation, circuitry related to branch prediction may still operate even through the branch prediction mode is disabled, thereby allowing the continued gathering of data regarding numbers of branches and the number of mispredictions over a predetermined period. Using data from the branch circuitry and counters 315, branch control circuitry 316 may re-enable branch prediction dependent upon the calculated rates of branches and branch mispredictions.

In one embodiment, IFU 310 may be configured to maintain a pool of fetched, ready-for-issue instructions drawn from among each of the threads being executed by core 210. For example, IFU 310 may include instruction buffer 315, which may be configured to store several recently-fetched instructions from corresponding threads. In some embodiments, IFU 310 may be configured to select multiple ready-to-issue instructions and concurrently issue (dispatch) the selected instructions to various functional units without constraining the threads from which the issued instructions are selected. As described below in more detail, the selection of the instructions may depend on one or more control bits associated with the instructions. In other embodiments, thread-based constraints may be employed to simplify the selection of instructions. For example, threads may be assigned to thread groups for which instruction selection is performed independently (e.g., by selecting a certain number of instructions per thread group without regard to other thread groups).

Instruction buffer 315 may include multiple banks, and each bank may include multiple dual-port memory cells. In some embodiments, control bits may be used to selectively activate banks with instruction buffer 315. The number of banks activated may correspond to a number of instructions selected for dispatch. Information encoded in the control bits may indicate limitations for a number of instructions that may be dispatched, thereby allowing for activating only banks containing instructions to be dispatched in a given processing cycle.

In some embodiments, IFU 310 may be configured to further prepare instructions for execution, for example by decoding instructions, detecting scheduling hazards, arbitrating for access to contended resources, or the like. Moreover, in some embodiments, instructions from a given thread may be speculatively issued from IFU 310 for execution. For example, a given instruction from a certain thread may fall in the shadow of a conditional branch instruction from that same thread that was predicted to be taken or not-taken, or a load instruction from that same thread that was predicted to hit in data cache 352, but for which the actual outcome has not yet been determined. In such embodiments, after receiving notice of a misspeculation such as a branch misprediction or a load miss, IFU 310 may be configured to cancel misspeculated instructions from a given thread as well as issued instructions from the given thread that are dependent on or subsequent to the misspeculated instruction, and to redirect instruction fetch appropriately.

Execution unit 330 may be configured to execute and provide results for certain types of instructions issued from IFU 310. In one embodiment, execution unit 330 may be configured to execute certain integer-type instructions defined in the implemented ISA, such as arithmetic, logical, and shift instructions. It is contemplated that in some embodiments, core 210 may include more than one execution unit 330, and each of the execution units may or may not be symmetric in functionality. Finally, in the illustrated embodiment instructions destined for FGU 340 or LSU 350 pass through execution unit 330. However, in alternative embodiments it is contemplated that such instructions may be issued directly from IFU 310 to their respective units without passing through execution unit 330.

Floating point/graphics unit 340 may be configured to execute and provide results for certain floating-point and graphics-oriented instructions defined in the implemented ISA. For example, in one embodiment FGU 340 may implement single- and double-precision floating-point arithmetic instructions compliant with a version of the Institute of Electrical and Electronics Engineers (IEEE) 754 Standard for Binary Floating-Point Arithmetic (more simply referred to as the IEEE 754 standard), such as add, subtract, multiply, divide, and certain transcendental functions. Also, in one embodiment FGU 340 may implement partitioned-arithmetic and graphics-oriented instructions defined by a version of the SPARC® Visual Instruction Set (VIS™) architecture, such as VIS™ 2.0. Additionally, in one embodiment FGU 340 may implement certain integer instructions such as integer multiply, divide, and population count instructions, and may be configured to perform multiplication operations on behalf of stream processing unit 240. Depending on the implementation of FGU 360, some instructions (e.g., some transcendental or extended-precision instructions) or instruction operand or result scenarios (e.g., certain abnormal operands or expected results) may be trapped and handled or emulated by software.

In the illustrated embodiment, FGU 340 may be configured to store floating-point register state information for each thread in a floating-point register file. In one embodiment, FGU 340 may implement separate execution pipelines for floating point add/multiply, divide/square root, and graphics operations, while in other embodiments the instructions implemented by FGU 340 may be differently partitioned. In various embodiments, instructions implemented by FGU 340 may be fully pipelined (i.e., FGU 340 may be capable of starting one new instruction per execution cycle), partially pipelined, or may block issue until complete, depending on the instruction type. For example, in one embodiment floating-point add operations may be fully pipelined, while floating-point divide operations may block other divide/square root operations until completed.

Load store unit 350 may be configured to process data memory references, such as integer and floating-point load and store instructions as well as memory requests that may originate from stream processing unit 360. In some embodiments, LSU 350 may also be configured to assist in the processing of instruction cache 314 misses originating from IFU 310. LSU 350 may include a data cache 352 as well as logic configured to detect cache misses and to responsively request data from L3 cache 230 via crossbar interface 370. In one embodiment, data cache 352 may be configured as a write-through cache in which all stores are written to L3 cache 230 regardless of whether they hit in data cache 352; in some such embodiments, stores that miss in data cache 352 may cause an entry corresponding to the store data to be allocated within the cache. In other embodiments, data cache 352 may be implemented as a write-back cache.

In one embodiment, LSU 350 may include a miss queue configured to store records of pending memory accesses that have missed in data cache 352 such that additional memory accesses targeting memory addresses for which a miss is pending may not generate additional L3 cache request traffic. In the illustrated embodiment, address generation for a load/store instruction may be performed by one of EXUs 330. Depending on the addressing mode specified by the instruction, one of EXUs 330 may perform arithmetic (such as adding an index value to a base value, for example) to yield the desired address. Additionally, in some embodiments LSU 350 may include logic configured to translate virtual data addresses generated by EXUs 330 to physical addresses, such as a Data Translation Lookaside Buffer (DTLB).

Crypto processing unit 360 may be configured to implement one or more specific data processing algorithms in hardware. For example, crypto processing unit 360 may include logic configured to support encryption/decryption algorithms such as Advanced Encryption Standard (AES), Data Encryption Standard/Triple Data Encryption Standard (DES/3DES), or Ron's Code #4 (RC4). Crypto processing unit 240 may also include logic to implement hash or checksum algorithms such as Secure Hash Algorithm (SHA-1, SHA-256), Message Digest 5 (MD5), or Cyclic Redundancy Checksum (CRC). Crypto processing unit 360 may also be configured to implement modular arithmetic such as modular multiplication, reduction and exponentiation. In one embodiment, crypto processing unit 360 may be configured to utilize the multiply array included in FGU 340 for modular multiplication. In various embodiments, crypto processing unit 360 may implement several of the aforementioned algorithms as well as other algorithms not specifically described.

Crypto processing unit 360 may be configured to execute as a coprocessor independent of integer or floating-point instruction issue or execution. For example, in one embodiment crypto processing unit 360 may be configured to receive operations and operands via control registers accessible via software; in the illustrated embodiment crypto processing unit 360 may access such control registers via LSU 350. In such embodiments, crypto processing unit 360 may be indirectly programmed or configured by instructions issued from IFU 310, such as instructions to read or write control registers. However, even if indirectly programmed by such instructions, crypto processing unit 360 may execute independently without further interlock or coordination with IFU 310. In another embodiment crypto processing unit 360 may receive operations (e.g., instructions) and operands decoded and issued from the instruction stream by IFU 310, and may execute in response to such operations. That is, in such an embodiment crypto processing unit 360 may be configured as an additional functional unit schedulable from the instruction stream, rather than as an independent coprocessor.

In some embodiments, crypto processing unit 360 may be configured to freely schedule operations across its various algorithmic subunits independent of other functional unit activity. Additionally, crypto processing unit 360 may be configured to generate memory load and store activity, for example to system memory. In the illustrated embodiment, crypto processing unit 360 may interact directly with crossbar interface 370 for such memory activity, while in other embodiments crypto processing unit 360 may coordinate memory activity through LSU 350. In one embodiment, software may poll crypto processing unit 360 through one or more control registers to determine result status and to retrieve ready results, for example by accessing additional control registers. In other embodiments, FGU 340, LSU 350 or other logic may be configured to poll crypto processing unit 360 at intervals to determine whether it has results that are ready to write back. In still other embodiments, crypto processing unit 360 may be configured to generate a trap when a result is ready, to allow software to coordinate result retrieval and processing.

L2 cache memory 390 may be configured to cache instructions and data for use by execution unit 330. In the illustrated embodiment, L2 cache memory 390 may be organized into multiple separately addressable banks that may each be independently accessed. In some embodiments, each individual bank may be implemented using set-associative or direct-mapped techniques.

L2 cache memory 390 may be implemented in some embodiments as a writeback cache in which written (dirty) data may not be written to system memory until a corresponding cache line is evicted. L2 cache memory 390 may variously be implemented as single-ported or multiported (i.e., capable of processing multiple concurrent read and/or write accesses). In either case, L2 cache memory 390 may implement arbitration logic to prioritize cache access among various cache read and write requestors.

In some embodiments, L2 cache memory 390 may be configured to operate in a diagnostic mode that allows direct access to the cache memory. For example, in such a mode, L2 cache memory 390 may permit the explicit addressing of specific cache structures such as individual sets, banks, ways, etc., in contrast to a conventional mode of cache operation in which some aspects of the cache may not be directly selectable (such as, e.g., individual cache ways). The diagnostic mode may be implemented as a direct port to L2 cache memory 390. Alternatively, crossbar interface 370 or MMU 320 may be configured to allow direct access to L2 cache memory 390 via the crossbar interface.

L2 cache memory 390 may be further configured to implement a BIST. An address generator, a test pattern generator, and a BIST controller may be included in L2 cache memory 390. The address generator, test pattern generator, and BIST controller may be implemented in hardware, software, or a combination thereof. The BIST may perform tests such as, e.g., checkerboard, walking 1/0, sliding diagonal, and the like, to determine that data storage cells within L2 cache memory 390 are capable of storing both a logical 0 and logical 1. In the case where the BIST determines that not all data storage cells within L2 cache memory 390 are functional, a flag or other signal may be activated indicating that L2 cache memory 390 is faulty.

As previously described, instruction and data memory accesses may involve translating virtual addresses to physical addresses. In one embodiment, such translation may occur on a page level of granularity, where a certain number of address bits comprise an offset into a given page of addresses, and the remaining address bits comprise a page number. For example, in an embodiment employing 4 MB pages, a 64-bit virtual address and a 40-bit physical address, 22 address bits (corresponding to 4 MB of address space, and typically the least significant address bits) may constitute the page offset. The remaining 42 bits of the virtual address may correspond to the virtual page number of that address, and the remaining 18 bits of the physical address may correspond to the physical page number of that address. In such an embodiment, virtual to physical address translation may occur by mapping a virtual page number to a particular physical page number, leaving the page offset unmodified.

Such translation mappings may be stored in an ITLB or a DTLB for rapid translation of virtual addresses during lookup of instruction cache 314 or data cache 352. In the event no translation for a given virtual page number is found in the appropriate TLB, memory management unit 320 may be configured to provide a translation. In one embodiment, MMU 250 may be configured to manage one or more translation tables stored in system memory and to traverse such tables (which in some embodiments may be hierarchically organized) in response to a request for an address translation, such as from an ITLB or DTLB miss. (Such a traversal may also be referred to as a page table walk.) In some embodiments, if MMU 320 is unable to derive a valid address translation, for example if one of the memory pages including a necessary page table is not resident in physical memory (i.e., a page miss), MMU 320 may be configured to generate a trap to allow a memory management software routine to handle the translation. It is contemplated that in various embodiments, any desirable page size may be employed. Further, in some embodiments multiple page sizes may be concurrently supported.

A number of functional units in the illustrated embodiment of core 210 may be configured to generate off-core memory or I/O requests. For example, IFU 310 or LSU 350 may generate access requests to L3 cache 230 in response to their respective cache misses. Crypto processing unit 360 may be configured to generate its own load and store requests independent of LSU 350, and MMU 320 may be configured to generate memory requests while executing a page table walk. Other types of off-core access requests are possible and contemplated. In the illustrated embodiment, crossbar interface 370 may be configured to provide a centralized interface to the port of crossbar 220 associated with a particular core 210, on behalf of the various functional units that may generate accesses that traverse crossbar 220. In one embodiment, crossbar interface 370 may be configured to maintain queues of pending crossbar requests and to arbitrate among pending requests to determine which request or requests may be conveyed to crossbar 220 during a given execution cycle. For example, crossbar interface 370 may implement a least-recently-used or other algorithm to arbitrate among crossbar to requestors. In one embodiment, crossbar interface 370 may also be configured to receive data returned via crossbar 110, such as from L3 cache 230 or I/O interface 250, and to direct such data to the appropriate functional unit (e.g., data cache 352 for a data cache fill due to miss). In other embodiments, data returning from crossbar 220 may be processed externally to crossbar interface 370.

During the course of operation of some embodiments of core 210, exceptional events may occur. For example, an instruction from a given thread that is picked for execution by pick unit 316 may be not be a valid instruction for the ISA implemented by core 210 (e.g., the instruction may have an illegal opcode), a floating-point instruction may produce a result that requires further processing in software, MMU 320 may not be able to complete a page table walk due to a page miss, a hardware error (such as uncorrectable data corruption in a cache or register file) may be detected, or any of numerous other possible architecturally-defined or implementation-specific exceptional events may occur. In one embodiment, trap logic unit 380 may be configured to manage the handling of such events. For example, TLU 380 may be configured to receive notification of an exceptional event occurring during execution of a particular thread, and to cause execution control of that thread to vector to a supervisor-mode software handler (i.e., a trap handler) corresponding to the detected event. Such handlers may include, for example, an illegal opcode trap handler configured to return an error status indication to an application associated with the trapping thread and possibly terminate the application, a floating-point trap handler configured to fix up an inexact result, etc.

In one embodiment, TLU 380 may be configured to flush all instructions from the trapping thread from any stage of processing within core 210, without disrupting the execution of other, non-trapping threads. In some embodiments, when a specific instruction from a given thread causes a trap (as opposed to a trap-causing condition independent of instruction execution, such as a hardware interrupt request), TLU 380 may implement such traps as precise traps. That is, TLU 380 may ensure that all instructions from the given thread that occur before the trapping instruction (in program order) complete and update architectural state, while no instructions from the given thread that occur after the trapping instruction (in program order) complete or update architectural state.

### Instruction Break Information

Each program instruction fetched from system memory may have architectural constraints or micro-architectural constraints that may affect a dispatch rate from an instruction buffer. For example, an instruction may be split into multiple micro operations (commonly referred to as “micro-ops”), each of which may occupy a dispatch slot within the instruction buffer. Additionally, an instruction may be limited to being dispatched from a given dispatch slot within the instruction buffer.

An instruction may be the oldest instruction in a given group of instructions to be dispatched (a “dispatch group”). This situation is commonly referred to as a “break-before.” In some cases, instructions that are younger than a given instruction may not be dispatched along with the given instruction. This situation is commonly referred to as “break-after.”

Such limitations on dispatch as described above, may be represented by a set of encoded data bits. The number of data bits used to encode the various situations may depend on the number of situations that are being detected. For example, in a case of five cases of “breaks,” three data bits may employed. Such data bits (also referred to herein as “control bits” and “break bits”) may be included with each fetched program instruction from system memory. In other embodiments, the value of the control bits may be determined during the fetch process. When an instruction is fetched, corresponding control bits may be stored in the instruction buffer with the fetched instruction. Alternatively, in other embodiments, the corresponding control bits may be stored in a memory external to the instruction buffer.

During an instruction dispatch, previously stored control bits may be used to determine a number of instructions to dispatch from an instruction buffer. The control bits may be decoded to determine if any limitations on dispatch are present. For example, in Table 1, a list of possible limitations on instruction dispatched is illustrated. It is noted that the limitations listed in Table 1 is merely an example. In other embodiments, different numbers and types of limitations are possible and contemplated.

TABLE 1
Example Limitations on Dispatch

read 0: No instructions may be read
read 1: 1 instruction may be read
read 2: At most 2 instructions may be read
read 3: At most 3 instructions may be read
read Dmax-1: At most Dmax-1 instructions may be read
(NOTE:
Dmax is the maximum number of dispatch slots)

### Instruction Buffer Operation

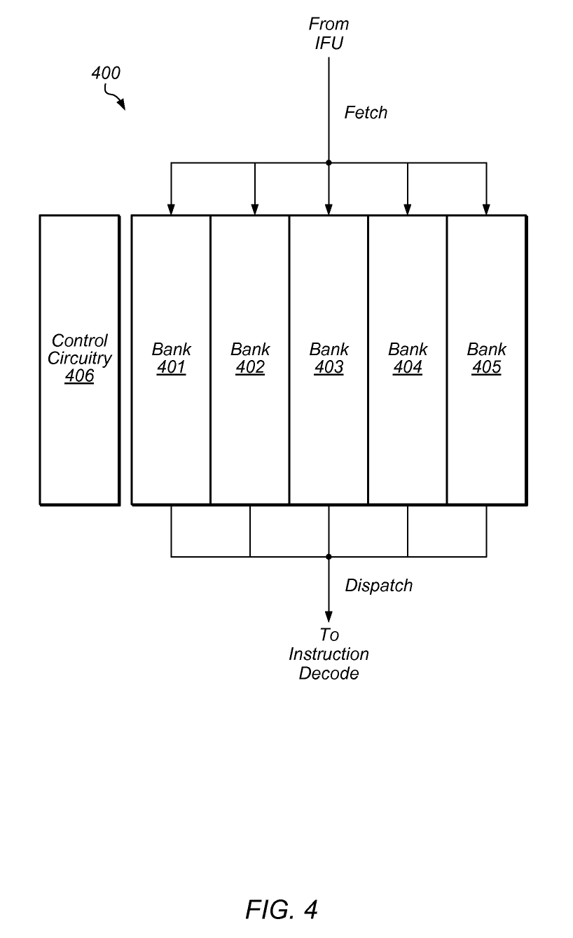

Turning to FIG. 4, an embodiment of an instruction buffer is illustrated. In the illustrated embodiment, instruction buffer 400 includes banks 401 through 405, and control circuitry 406. Each of banks 401 through 405 is configured to receive program instructions from an IFU, such as, e.g., IFU 310 as illustrated in FIG. 3, during a fetch operation. Moreover, each of banks 401 through 405 may be configured to send previously stored program instructions to instruction decode circuitry during a dispatch operation.

Each of banks 401 through 405 may, in various embodiments, include multiple dual-port memory cells (not shown). A dual-port memory cell may include separate read and write ports allowing for data to be written to a given memory cell in parallel with data being read from the given memory cell. In various embodiments, data written to a dual-port memory cell may be differentially encoded. Data read from such a dual-port cell may also be differentially encoded. In some embodiments, a read port of a dual-port memory cell may output data in a single-ended fashion.

Control circuitry 406 may be configured to receive activation signals from other parts of a processor core, such as, processor core 210, for example. In some embodiments, control circuitry 406 may, in response to an activation signal, generate internal timing and control signals necessary to write data into, or read data from one or more memory cells within banks 401 through 405. Such timing and control signals may, for example, control the activation of sense amplifiers and write driver circuits within banks 401 through 405.

In some embodiments, control circuitry 406 may include one or more decoders (not shown). The decoders may be configured to decode received addresses to determine locations within banks 401 through 405 for read and write operations. In other embodiments, control circuitry 406 may be configured to maintain two pointers (a read pointer and a write pointer) which are used to select locations within banks 401 through 405 for read and write operations, respectively. Control circuitry 406 may increment each pointer by a predetermined value in response to the completion of respective read and write operations, and in preparation for a next read or write operation.

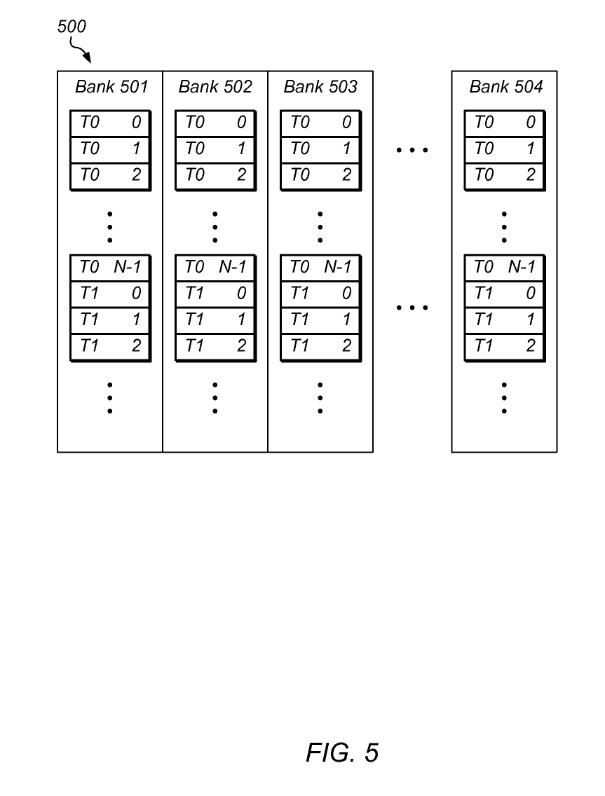

Control circuitry 406 may also include, in some embodiments, circuitry for reading and writing control bits, such as those described above, to a memory external to instruction buffer 500. As will be described in more detail below in regard to FIG. 5, during dispatch operations, control circuitry 406 may read control bits from the external memory, decode the read control bits, and use the decoded information to determine which bank(s) to activate. By using the break information contained in the control bits, to selectively activate banks, instruction buffer 400 may, in some embodiments, reduce power consumption.

It is noted that the embodiment illustrated in FIG. 4 is merely an example. In other embodiments, different numbers of banks and different methods for pointer management may be employed.

Moving to FIG. 5, a block diagram of program instructions stored in a multi-bank instruction buffer is illustrated. In the illustrated embodiment, instruction buffer 500 includes banks 501 through 504. For the sake of clarity, control circuitry, such as, e.g., control circuitry 406 as illustrated in FIG. 4, has been omitted Although only four banks are depicted, in other embodiments, any suitable number of banks may be employed. In some embodiments, the number of banks employed may correspond to a maximum number of instructions that may be fetched at one time.

Each of banks 501 through 504 includes multiple entries. Individual threads may be allotted a predetermined number of entries. For example, in the illustrated embodiment, thread T0 is allocated N (where N is a positive integer) entries (labeled “T0 0” through “T0 N−1”) in each of banks 501 through 504. The overall depth, i.e., number of entries, in a given bank, may depend on a maximum number of threads supported.

During operation, an IFU unit, such as, e.g., IFU 310 as illustrated in FIG. 3, fetches a number of instructions from memory. Each of the fetched instructions may be stored in a separate bank according to a thread to which the instructions belong. A write pointer may, in various embodiments, indicate a starting location for storing the fetched instructions. Following the storage of the fetched instructions, the write pointer may be incremented by a number of instructions stored, thereby providing a new starting location for a subsequent storage of fetched instructions. As instructions are being fetched and stored into instruction buffer 500, stored instructions are being dispatched, i.e., retrieved from locations within banks 501 through 504 and sent to an instruction decoder or other suitable functional blocks within a processor core.

In some embodiments, a maximum number of instructions that may be dispatched at a given time may be less than a maximum number of instructions that may be fetched. Instructions to be dispatched may each be assigned a dispatch slot, with the oldest instruction in the instructions to be dispatched being assigned to a slot that will be dispatched first. In some embodiments, a read pointer indicates a location from which instructions will be dispatched. Following the dispatch of the instructions, the read pointer may be incremented thereby providing a new starting location for subsequent instruction dispatches from instruction buffer 500.

In some embodiments, control bits (as described above) may be employed in conjunction with the read pointer to determine which bank(s) of banks 501 through 504 may be activated during an instruction dispatch. A separate activation signal may be generated for each bank of an instruction buffer. Control circuitry, such as, e.g., control circuitry 406 as illustrated in FIG. 4, may employ one or more logic circuits to implement a desired Boolean function and generate such an activation signal. An example of

### Example 1

### Logical Equation for Bank 0 Access

read_b0=read_enable & (all_banks_enabled|\
   read_bank_ptr==0|\
   read_bank_ptr==bFmax-1 & ˜read1|\
   read_bank_ptr==bFmax-2 & ˜read2)
(NOTE: bFmax is the number of banks in the instruction buffer)

In Example 1, the signal all_banks_enabled is a generic signal which may be sent to all banks of an instruction buffer indicating that control bit information may be ignored. In some embodiments, such a signal may be employed when there is a timing limitation on determining a starting read address or corresponding break information. For example, a back-to-back dispatch of the instructions from the same thread may not provide sufficient time for performing calculations, such as those illustrated in Example 1, resulting in all banks of the instruction buffer being activated. While only an equation for the activation of bank 0 of an instruction buffer is illustrated in Example 1, it is noted that an activation signal for each bank may be generated in a similar fashion.

The diagram of FIG. 5 depicted the storage of instructions in a multi-bank instruction buffer is an example. In other embodiments, different organization of program instructions within the multi-bank instruction buffer are possible and contemplated.

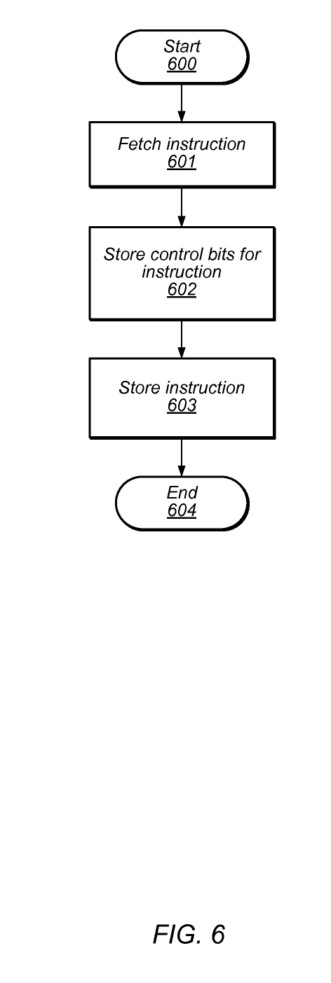

Moving to FIG. 6, a flow diagram depicting an embodiment of method for operating an instruction buffer is illustrated. The method begins in block 600. An instruction may then be fetched (block 601). In some embodiments, an IFU, such as, e.g., IFU 310 as illustrated in FIG. 3, may fetch one or more program instructions from system memory. Each fetched instruction may include one or more control bits encoding information regarding possible limitations on dispatch of a corresponding fetched instruction. In other embodiments, the one or more control bits may be determined after a corresponding instruction has been fetched from system memory.

Once an instruction has been fetched, corresponding control bits may then be stored (block 602). The control bits may be stored in an instruction buffer, such as, e.g., instruction buffer 400 as illustrated in FIG. 4. In other embodiments, the control bits may be stored in a memory external to the instruction buffer.

The fetched instruction may also then be stored in the instruction buffer (block 603). In some embodiments, the fetched instruction is stored at location within a block of the instruction buffer specified by a write pointer. The write pointer may then be incremented thereby providing a new target block for the storage of subsequent fetched instructions. With the fetched instruction stored, the method may conclude in block 604.

Although the operations of the flow diagram of FIG. 6 are depicted as being performed in a serial fashion, in other embodiments, one or more of the operations may be performed in parallel.

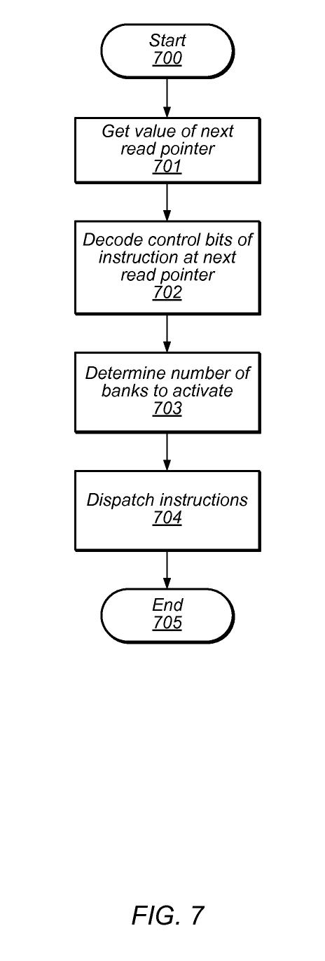

Turning to FIG. 7, a flow diagram illustrating an embodiment of another method for operating an instruction buffer is illustrated. The method begins in block 700. The value of a read pointer may then be obtained (block 701). In some embodiments, the read pointer may include a value indicative of one of multiple banks included in an instruction buffer. The read pointer may, in other embodiments, include additional information to further specify a location from where to retrieve previously stored instructions in instruction buffer.

Control bits corresponding to the instruction stored at the location indicated by the read pointer may then be decoded (block 702). In some embodiments, the control bits may be read from a memory external to the instruction buffer, while, in other embodiments, the control bits may be read from a location within the instruction buffer. Control circuitry, such as control circuitry 406, may, in some embodiments, decode the controls bit upon retrieving the control bits from memory.

With the control bits decoded, a number of banks to activate within the instruction buffer may then be determined (block 703). In some embodiments, the number of banks may correspond to a number of instructions that are to be dispatched. The banks may be activated through the generation of corresponding activation signals. Such activation signals may be generated by one or more logic circuits dependent upon the decoded control bits. In some cases, no banks may be activated, while, in other cases, all banks may be activated. From each activated bank, an instruction is read in preparation for dispatch. By selectively enabling banks within the instruction buffer, power consumption may be reduced in cases where various factors limit the number of instructions that may be dispatched.

Once the desired banks have been activated and instructions read from the activated banks, the instructions may be dispatched (block 704). As the instructions are being dispatched, the read pointer may be incremented. In some embodiments, the read pointer may be incremented by a number equal to the instructions dispatched. Once the instructions have been dispatched, the method may conclude in block 705.

It is noted that the method depicted in the flow diagram of FIG. 7 is merely an example. In other embodiments, different operations and different orders of operations may be employed.

Numerous variations and modifications will become apparent to those skilled in the art once the above disclosure is fully appreciated. It is intended that the following claims be interpreted to embrace all such variation and modifications.

What is claimed is:

1. An apparatus, comprising:
a plurality of banks, wherein each bank of the plurality of banks stores a respective one of a plurality of instructions; and
circuitry configured to:
receive a read pointer, wherein the read pointer includes a value indicative of a given bank of the plurality of banks;
select a subset of the plurality of banks dependent upon the read pointer and one or more control bits associated with an instruction stored at a location specified by the read pointer;
activate the subset of the plurality of banks; and
read an instruction from each bank of the subset of the plurality of banks to generate a dispatch group.

2. The apparatus of claim 1, wherein to select the subset of the plurality of banks, the circuitry is further configured to read the one or more control bits from a memory.

3. The apparatus of claim 1, wherein the circuitry is further configured to increment the read pointer responsive to a determination that reading an instruction from each bank of the subset of the plurality of banks has completed.

4. The apparatus of claim 1, wherein the one or more control bits include information indicative of a number of micro-operations included in the instruction stored at the location specified by the read pointer.

5. The apparatus of claim 1, wherein the one or more control bits include information indicative that the instruction stored at the location specified by the read pointer is older than remaining instructions in the dispatch group.

6. The apparatus of claim 1, wherein each bank of the plurality of banks includes a plurality of memory cells, and wherein each memory cell of the plurality of memory cells includes a write port and a read port.

7. A method, comprising:
fetching a plurality of instructions, wherein each instruction of the plurality of instructions includes one or more control bits;
storing each instruction of the plurality of instructions in a respective one of a plurality of banks of a first memory;
selecting a subset of the plurality of banks dependent upon a read pointer and one or more control bits included in an instruction stored at a location in the first memory indicated by the read pointer;
activating the subset of the plurality of banks; and
reading an instruction from each bank of the subset of the plurality of banks to generate a dispatch group.

8. The method of claim 7, wherein storing each instruction of the plurality of instructions comprises storing the one or more control bits of each instruction of the plurality of instructions in a second memory.

9. The method of claim 7, wherein storing each instruction of the plurality of instructions comprises incrementing a write pointer, wherein the write pointer includes information indicative of a location within a given bank of the plurality of banks.

10. The method of claim 7, wherein the one or more control bits included in the instruction stored at the location in the first memory indicated by the read pointer include information indicative of a number of micro-operations included in the instruction stored at the location in the first memory indicated by the read pointer.

11. The method of claim 7, wherein the one or more control bits included in the instruction stored at the location in the first memory indicated by the read pointer include information indicative that the instruction stored at the location in the first memory indicated by the read pointer is older than remaining instructions in the dispatch group.

12. The method of claim 7, wherein each bank of the plurality of banks includes a plurality of memory cells, and wherein each memory cell of the plurality of memory cells includes a write port and a read port.

13. The method of claim 7, further comprising incrementing the read pointer responsive to a determination that reading an instruction from each bank of the subset of the plurality of banks has completed.

14. A system, comprising:
a first memory including a plurality of banks; and
a processor coupled to the first memory, wherein the processor is configured to:
receive a read pointer, wherein the read pointer includes a value indicative of a given one bank of the plurality of banks;
select a subset of the plurality of banks dependent upon the read pointer and one or more control bits associated with an instruction stored at a location specified by the read pointer;
activate the subset of the plurality of banks; and
read an instruction from each bank of the subset of the plurality of banks to generate a dispatch group

15. The system of claim 14, wherein to select the subset of the plurality of banks, the processor is further configured to decode the one or more control bits associated with the instruction stored at the location specified by the read pointer.

16. The system of claim 14, wherein the processor is further configured to increment the read pointer responsive to a determination that reading an instruction from each bank of the subset of the plurality of banks has completed.

17. The system of claim 14, wherein the one or more control bits include information indicative of a number of micro-operations included in the instruction stored at the location specified by the read pointer.

18. The system of claim 14, wherein to select the subset of the plurality of banks, the processor is further configured to retrieve the one or more control bits associated with the instruction stored at the location specified by the read pointer from a second memory.

19. The system of claim 14, wherein the one or more control bits include information indicative that the instruction stored at the location in the first memory indicated by the read pointer is older than remaining instructions in the dispatch group.

20. The system of claim 14, wherein each bank of the plurality of banks includes a plurality of memory cells, and wherein each memory cell of the plurality of memory cells includes a write port and a read port.
